(19) United States
(12) Patent Application Publication
(10) Pub. No.: US 2020/0142670 A1
(43) Pub. Date: May 7, 2020

(54) Radix-23 Fast Fourier Transform for an Embedded Digital Signal Processor

(71) Applicants: Marwan A. Jaber, Saint-Leonard (CA); Radwan A. Jaber, Saint-Leonard (CA); Daniel Massicotte, Trois-Rivieres (CA)

(72) Inventors: Marwan A. Jaber, Saint-Leonard (CA); Radwan A. Jaber, Saint-Leonard (CA); Daniel Massicotte, Trois-Rivieres (CA)

(21) Appl. No.: 16/425,792

(22) Filed: May 29, 2019

Related U.S. Application Data
(60) Provisional application No. 62/677,610, filed on May 29, 2018.

(51) Int. Cl. G06F 7/49; G06F 7/501; G06F 5/01; G06F 17/14

(52) U.S. Cl. CPC G06F 7/49; G06F 17/142; G06F 5/01; G06F 7/501

(57) ABSTRACT

In some embodiments, a circuit may include an input configured to receive a signal and a radix-2³ fast Fourier transform (FFT) processing element coupled to the input. The radix-2³ FFT processing element may be configured to control variation of twiddle factors during calculation of a complete FFT through a plurality of processing stages. The radix-2³ FFT processing element may be configured to incorporate the twiddle factors and adder tree matrices of the calculation into a single stage.

### CROSS-REFERENCE TO RELATED APPLICATION(S)

The present disclosure is a non-provisional of and claims priority to U.S. Provisional Patent Application No. 62/677,610 filed on May 29, 2019 and entitled “Radix-2³ Fast Fourier Transform for an Embedded Digital Signal Processor”, which is incorporated herein by reference in its entirety.

### FIELD

The present disclosure is generally related to devices, systems, and methods configured to determine a fast Fourier transform (FFT), and more particularly to a radix-2³ FFT that can be embedded in a digital signal processor (DSP).

### BACKGROUND

The Discrete Fourier Transform (DFT) is a mathematical procedure that is used in a wide variety of applications, from image processing to radio communications. Further, the DFT can be implemented in computers or dedicated circuitry. Further, the DFT is at the center of the processing that takes place inside a digital signal processor.

It is known that a DFT can be written as the sum of two discrete Fourier transforms, each of length N/2. One of the two DFTs can be formed from the even-numbered points of the original data of size N, and the other from the odd-numbered points. The Fast Fourier Transform allowed the DFT to be evaluated with a significant reduction in the amount of calculation required, allowing the DFT of a sampled signal to be obtained rapidly and efficiently.

### SUMMARY

In some embodiments, circuits, devices, systems, and methods described herein may enhance the efficiency of a DFT operation used to process input/output data by avoiding trivial multiplication operations. In some embodiments, the circuits, devices, systems and methods may utilize a simple mapping from the three indices (FFT stage, butterfly, and element) to the addresses of the input/output data with its corresponding multiplier coefficients.

In some embodiments, a radix-2³ FFT can be used to reduce a computational load by reducing an amount of the coefficient's multipliers (Twiddle Factors) utilized to compute an FFT as compared to the conventional radix-2 FFT. In a particular embodiment, the radix-2³ FFT can be configured to reduce the memory accesses, and further, the multiplication by

$$\pm \frac{\sqrt{2}}{2} \pm j \frac{\sqrt{2}}{2} can$$

be also predicted where the number of arithmetical operation required for the complex multiplication can be reduced from 6 to 2, thereby improving computational performance.

In some embodiments, a circuit may include an input configured to receive a signal and a radix-2³ fast Fourier transform (FFT) processing element coupled to the input. The radix-2³ FFT processing element may be configured to control variation of twiddle factors during calculation of a complete FFT through a plurality of processing stages. The radix-2³ FFT processing element may be configured to incorporate the twiddle factors and adder tree matrices of the calculation into a single stage.

### BRIEF DESCRIPTION OF THE DRAWINGS

FIG. 1 depicts a graph of a Discrete Fourier Transform (DFT) decomposition.

FIG. 2 depicts three stages in the computation of an 8-point Decimation in Time (DIT) DFT.

FIG. 3 depicts a graph of a basic butterfly computation for the DIT FFT algorithm.

FIG. 4 depicts a signal flow graph of an 8-point DIT FFT.

FIG. 5 depicts three stages of an 8-point DIF FFT algorithm.

FIG. 6 depicts a butterfly computation for a decimation in frequency (DIF) FFT algorithm.

FIG. 7 depicts stages of an 8-point DIF FFT algorithm.

FIG. 8 depicts a radix-8 DIT butterfly, in accordance with certain embodiments of the present disclosure.

FIG. 9 depicts a signal flow graph of an 8-point DIT FFT, in accordance with certain embodiments of the present disclosure.

FIG. 10 depicts a graph of the 8^{th} root of unity, in accordance with certain embodiments of the present disclosure.

FIG. 11 depicts a graph of a Radix-2³ FFT butterfly structure for a trivial computation, in accordance with certain embodiments of the present disclosure.

FIG. 12 depicts a graph of a Radix-2³ FFT butterfly structure for a non-trivial computation, in accordance with certain embodiments of the present disclosure.

FIG. 13 depicts a graph of a percentage reduction of clock cycles as a function of the FFT length for a timing clock and a reference clock, in accordance with certain embodiments of the present disclosure.

FIG. 14 depicts a block diagram of a signal processing system including a Radix-2³ FFT butterfly structure, in accordance with certain embodiments of the present disclosure.

In the following discussion, the same reference numbers are used in the various embodiments to indicate the same or similar elements.

### DETAILED DESCRIPTION OF ILLUSTRATIVE EMBODIMENTS

circuits, devices, systems, and methods described herein may enhance the efficiency of a DFT operation used to process input/output data by avoiding trivial multiplication operations. In some embodiments, the circuits, devices, systems and methods may utilize a simple mapping from the three indices (FFT stage, butterfly, and element) to the addresses of the input/output data with its corresponding multiplier coefficients.

In some embodiments, a radix-2³ FFT can be used to reduce a computational load by reducing an amount of the coefficient's multipliers (Twiddle Factors) utilized to compute an FFT as compared to the conventional radix-2 FFT. In a particular embodiment, the radix-2³ FFT can be configured to reduce the memory accesses, and further, the multiplication by

$$\pm \frac{\sqrt{2}}{2} \pm j \frac{\sqrt{2}}{2} can$$

be also predicted where the number of arithmetical operation required for the complex multiplication can be reduced from 6 to 2, thereby improving computational performance.

In some embodiments, a circuit may include an input configured to receive a signal and a radix-2³ fast Fourier transform (FFT) processing element coupled to the input. The radix-2³ FFT processing element may be configured to control variation of twiddle factors during calculation of a complete FFT through a plurality of processing stages. The radix-2³ FFT processing element may be configured to incorporate the twiddle factors and adder tree matrices of the calculation into a single stage.

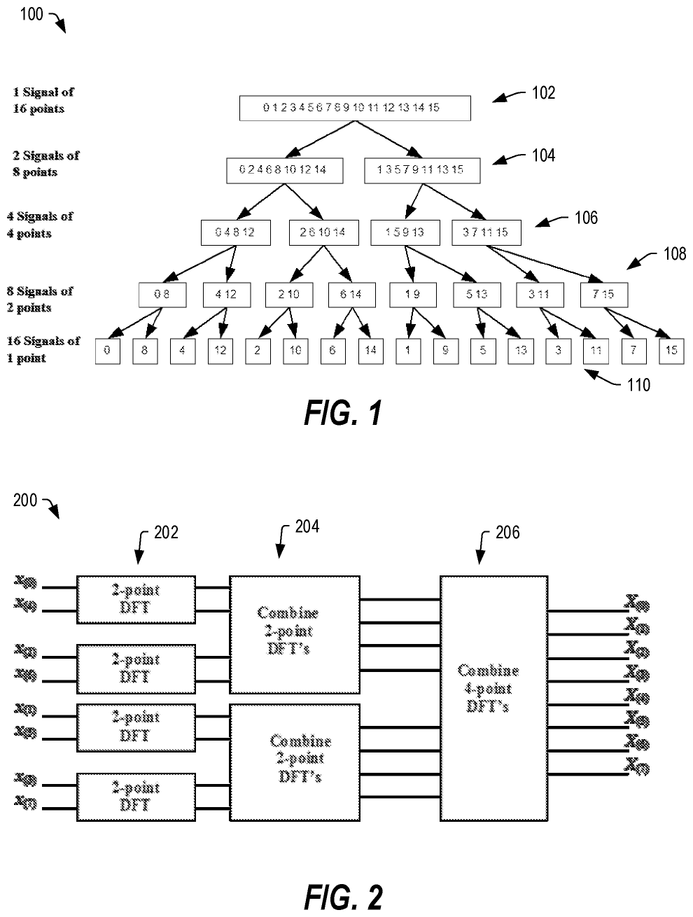

FIG. 1 depicts a graph 100 of a Discrete Fourier Transform (DFT) decomposition. The definition of the DFT is represented by the following equation

X_{[k]}=Σₙ₌₀^{N-1}x_{[n]}w_{N}^{nk}, k∈[0,N−1], (Equation 1)

where x[n] is the input sequence, X[k] is the output sequence, N is the transform length,

$${w}_{N}^{nk} = {e}^{- j ( \frac{2 π}{N} ) nk}$$

is called the twiddle factor in butterfly structure, and j2=−1. Both x[n] and X[k] are complex number sequences.

The graph 100 depicts a sixteen-bit input sequence at 102, which can be decomposed into two signals of eight bits each as shown at 104. It should be understood that a decimation-in-time (DIT) FFT algorithm (sometimes called a “Cooley-Tukey FFT algorithm”) first rearranges the input elements into bit-reverse order, and then builds up the output transform in log₂N iterations. In the DIT process, the input data is subdivided into two sets of even-numbered and odd numbered data, as shown by the first decomposition 104 in the graph 100. The two signals of eight bits can be further decomposed into four signals of four bits each, as shown at 106. The four signals of four bits each can be decomposed into eight signals of two bits each, at 108. The eight signals can be further decomposed into sixteen signals of one bit each, at 110.

If N/2 is even, as it is when N is equal to power of 2, then the DFTs of each of the N/2 points can be computed by breaking each of the sums into two N/4 points DFTs, which can be combined to yield the N/2 points DFTs. In the example of FIG. 1, an N point signal can be decomposed into N signals, each of which includes a single point. In some embodiments, each stage may use an interlace decomposition, separating the even and odd numbered samples. If the system is configured to decompose the four signals into eight signal point transforms, the system may decompose N into N/4 and N/4 into N/8 points transforms. The system may continue until left with only 2 points transforms, this requires m stages where m=log₂N, as shown in FIG. 2.

FIG. 2 depicts a system 200 including three stages 202, 204, and 206 in the computation of an 8-point Decimation in Time (DIT) DFT. At a first stage 202, a two-point DFT receives two inputs and provides two outputs. At a second stage 204, the block combines four inputs from the first stage 202 and provides four outputs. At a third stage 206, the block combines four-point DFTs to produce an eight-point DIT DFT.

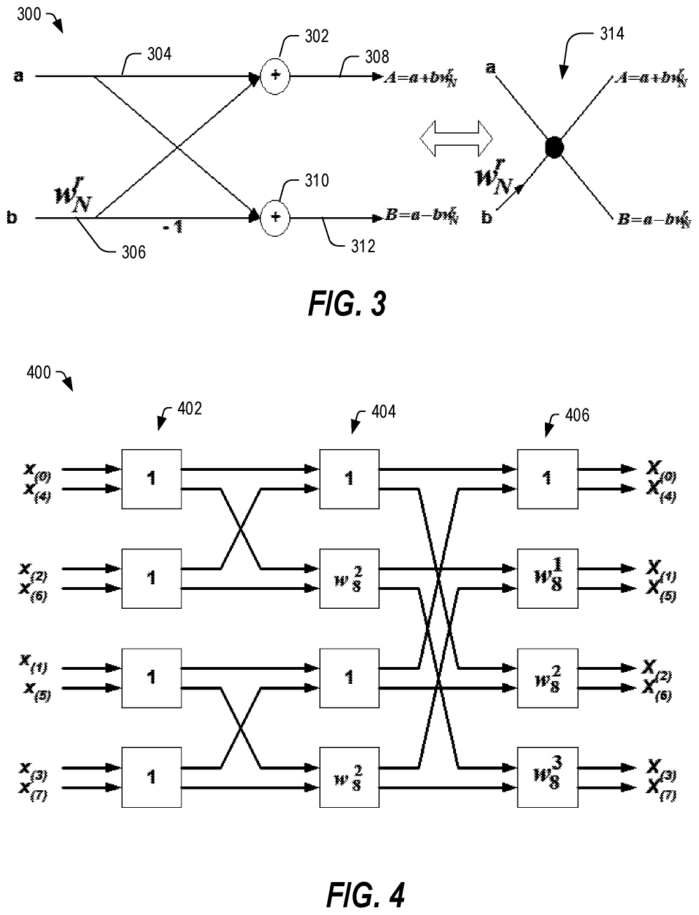

FIG. 3 depicts a graph 300 of a basic butterfly computation for the DIT FFT algorithm. The graph 300 may include a summing node 302 including a first input coupled to a node 304, a second input coupled to a node 306, and an output coupled to a node 308. The graph 300 may include a summing node 310 including a first input coupled to a node 304, a second input coupled to a node 306, and an output coupled to a node 312. The graph 300 further includes a butterfly operation 314 coupled to the inputs 308 and 312. Other embodiments are also possible.

It is also possible to derive FFT algorithms that first go through a set of log2 N iterations on the input data and rearrange the output values into bit-reverse order. This type of FFT algorithm is sometimes referred to as a decimation-in-frequency (DIF) or Sande-Tukey FFT algorithm. An example of an 8-point DIT FFT is described below with respect to FIG. 4.

FIG. 4 depicts a signal flow graph 400 of an 8-point DIT FFT. The output sequences X₍ₖ₎ are decimated (split) into the even-numbered samples and odd-numbered samples. Then, the DIF is obtained by performing the butterfly computation (in place computation or post multiplication technique).

Briefly, the basic operation of a radix-r butterfly includes combining r inputs to provide r outputs via the following operation:

X=Bᵣx, (Equation 2)

where x=[x₍₀₎, x₍₁₎, . . . , x₍ᵣ₋₁₎]^{T} is the input vector, X=[X₍₀₎, X₍₁₎, . . . , X₍ᵣ₋₁₎]^{T} is the output vector, and T denotes the transpose of the vector.

The value Bᵣ is the r×r butterfly matrix, which can be expressed as follows:

Bᵣ=W_{N}Tᵣ, (Equation 3)

for the decimation in frequency (DIF) process. The value Bᵣ of the r×r butterfly matrix for the decimation in time (DIT) process can be expressed as follows:

Bᵣ=TᵣW_{N} (Equation 4)

where, for both cases, the value W_{N} is defined as follows:

$$\begin{matrix}{W}_{N} = diag ( {w}_{N}^{0} , {w}_{N}^{p} , {w}_{N}^{2 p} , … , {w}_{N}^{( r - 1 ) p} ) , \\ and & ( Equation 5 ) \\ {T}_{t} = [ \begin{matrix}{w}_{N}^{0} & {w}_{N}^{0} & {w}_{N}^{0} & … & … & {w}_{N}^{0} \\ {w}_{N}^{0} & {w}_{N}^{N / r} & {w}_{N}^{2 N / r} & … & … & {w}_{N}^{( r - 1 ) N / r} \\ {w}_{N}^{0} & {w}_{N}^{2 N / r} & {w}_{N}^{4 N / r} & … & … & {w}_{N}^{2 ( r - 1 ) N / r} \\ ⋮ & ⋮ & ⋮ & ⋮ & ⋮ & ⋮ \\ ⋮ & ⋮ & ⋮ & ⋮ & ⋮ & ⋮ \\ {w}_{N}^{0} & {w}_{N}^{( r - 1 ) N / r} & {w}_{N}^{2 ( r - 1 ) N / r} & … & … & {w}_{N}^{{( r - 1 )}^{2} N / r}\end{matrix} ] . & ( Equation 6 )\end{matrix}$$

The signal flow graph 400 may include a first stage 402, a second stage 404, and a third stage 406, which may be configured to receive eight inputs and to generate an eight-point DIF FFT output.

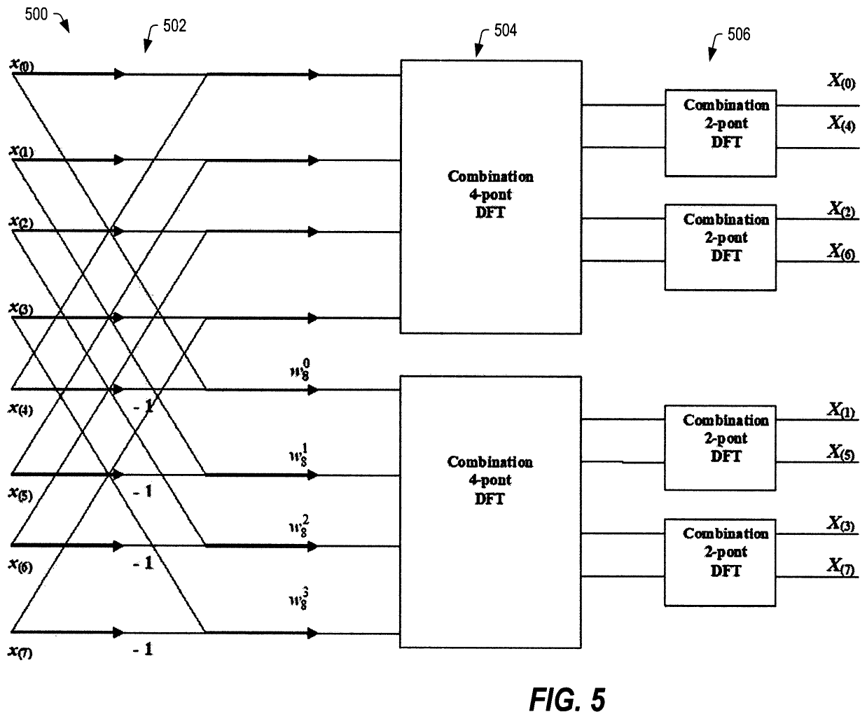

FIG. 5 depicts three stages of an 8-point DIF FFT algorithm 500. The algorithm 500 may include a first stage 502, a second stage 504, and a third stage 506. The first stage 502 may receive eight inputs and may produce eight inputs for the second stage 504, which produces eight outputs. The third stage 506 may receive the eight outputs of the second stage 504 and may produce the DIF FFT output.

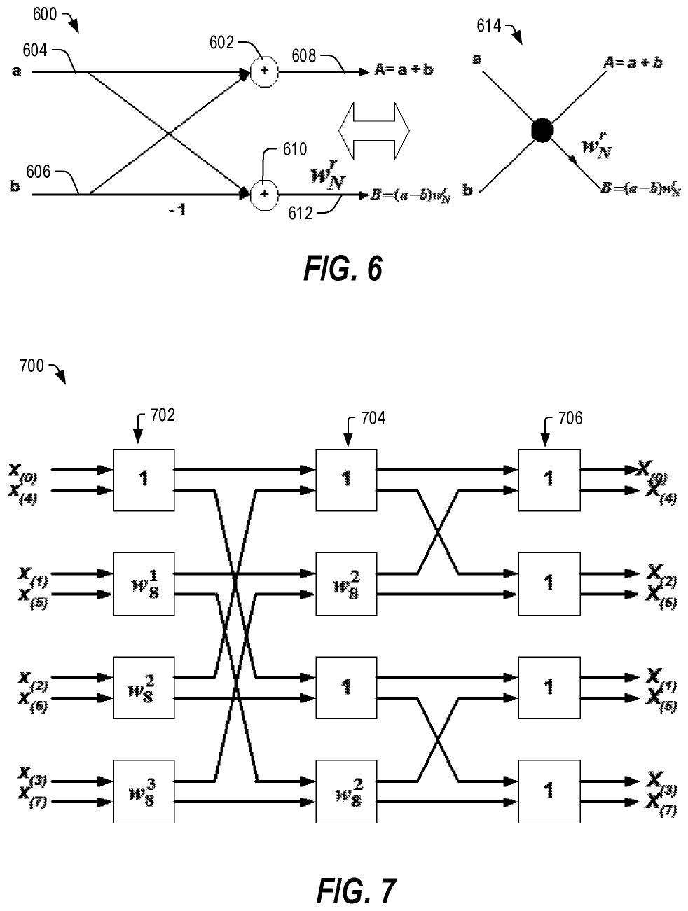

FIG. 6 depicts a butterfly computation 600 for a decimation in frequency (DIF) FFT algorithm. The computation 600 may include a summing node 602 including a first input coupled to a node 604, a second input coupled to a node 606, and an output coupled to a node 608. The computation 600 may further include a summing node 610 including a first input coupled to the node 604, a second input coupled to the node 606, and an output coupled to a node 612. The computation 600 may further include a multiplication stage 614.

FIG. 7 depicts stages of an 8-point DIF FFT algorithm 700. The algorithm 700 may include a first stage 702, a second stage 704, and a third stage 706 that may cooperate to sort the output data in normal order to provide an output in bit-reversed order.

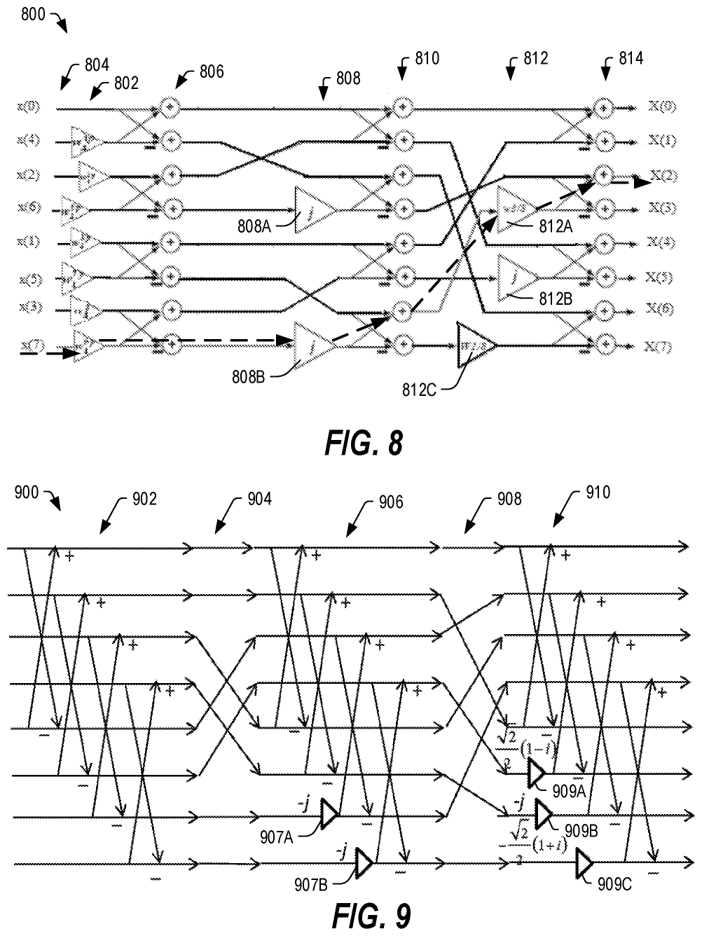

One of the bottlenecks in most applications, where high performance is required, is the FFT/IFFT processor. Given that higher radix implementations are attractive for reduction in computations, researchers have sought a higher radix butterfly implementation, because the higher radix will reduce automatically the communication load. However, the higher radix has typically added to the computational load. While attempts have been made to reduce the computational load by factoring the adder matrix (or by simplification of adder tree), conventional attempts have not provided a complete solution for the FFT problem due to the increasing complexity of the butterflies for higher radices introduced by the added multipliers in the butterfly's critical path, as depicted in FIG. 8.

FIG. 8 depicts a radix-8 DIT butterfly 800, in accordance with certain embodiments of the present disclosure. In this example, the radix-8 DIT butterfly 800 may include a plurality of multiplier nodes 802, which are each coupled to one of a plurality of inputs 804. The butterfly 800 may further include a plurality of summing nodes 806, 810, and 814, and additional multiplier nodes 808 and 812. In this example, the multiplier node 808B and the multiplier node 812A may be in a critical path and may represent additional multipliers that may not be present in lower valued radices and thus add to the computational load. In FIG. 8, the dashed line may represent a butterfly critical path.

It should be appreciated that the elements of the adder tree matrix Tᵣ and the elements of the twiddle factor matrix both contain twiddle factors. By controlling the variation of the twiddle factors during the calculation of a complete FFT, the twiddle factors and the adder tree matrices can be incorporated in a single stage of calculation.

Therefore, by defining [Tᵣ]_{l,m} as the element at the l^{th} line and m^{th} column in the matrix Tᵣ as a result, Equation 6 can be rewritten as follows:

$${[ {T}_{r} ]}_{l , m} = {w}_{N}^{{〚 ( l m \frac{N}{r} ) 〛}_{N}} , \qquad ( Equation 7 )$$

where l=0, 1, . . . , r−1, m=0, 1, . . . , r−1 and [symbol] x [symbol] _{N} represents the operation x modulo N. Further, by defining W_{N(m,v,s)}, the set of the twiddle factor matrix can be determined as follows:

[W_{N}]_{l,m(v,s)}=diag(w_{N(0,v,s)},w_{N(1,v,s)}, . . . , w_{N(r-1,v,s)}), (Equation 8)

where the indices r is the FFT's radix, v=0, 1, . . ., V−1 represents the number of words of size r

$$( V = \frac{N}{r} ) ,$$

and s=0, 1, . . . , S is the number of stages (or iterations S=logᵣ N−1).

Finally, Equation 8 could be expressed for the different stages in an FFT process as follows:

$${[ {W}_{N} ]}_{l , m ( v , s )} = \{ \begin{matrix}{w}_{N}^{{〚 ⌊ \frac{v}{{r}^{s}} ⌋ l {r}^{s} 〛}_{N}} & for l = m \\ 0 & elsewhere\end{matrix} , \qquad ( Equation 9 )$$

for the DIF process. For the DIT process, Equation 8 can be expressed as follows:

$${[ {W}_{N} ]}_{l , m ( v , s )} = \{ \begin{matrix}{w}_{N}^{{〚 ⌊ \frac{v}{{r}^{( S - s )}} ⌋ l {r}^{( S - s )} 〛}_{N}} & for l = m \\ 0 & elsewhere\end{matrix} , \qquad ( 10 )$$

for the DIT Process, where l=0, 1, . . . r−1 is the l^{th} butterfly's output, m=0, 1, . . . , r−1 is the m^{th} butterfly's input, and └x┘ represents the integer part operator of x.

Consequently, the l^{th} transform output during each stage could be illustrated as follows:

$${X}_{( v , s )} [ l ] = {\sum }_{m = 0}^{r - 1} {x}_{( v , s )} [ m ] {w}_{N}^{{〚 l m \frac{N}{r} + ⌊ v / {r}^{s} ⌋ l {r}^{s} 〛}_{N}} , \qquad ( Equation 11 )$$

for the DIF process, and could be expressed as follows for the DIT process:

$${X}_{( v , s )} [ l ] = {\sum }_{m = 0}^{r - 1} {x}_{( v , s )} [ m ] {w}_{N}^{{〚 l m \frac{N}{r} + ⌊ v / {r}^{( S - s )} ⌋ m {r}^{( S - s )} 〛}_{N}} . \qquad ( Equation 12 )$$

The read address generator (RAG), write address generator (WAG), and coefficient address generator (CAG) can be written for DIF and DIT processes, respectively. The mth butterfly's input of vth word x(m) at the sth stage (sth iteration) can be determined as follows:

$${RAG}_{( m , v , 0 )} = m \times \frac{M}{r} + v . \qquad ( Equation 13$$

For s>0, the read address generator can determine the read address as follows:

$${RAG}_{( m , v , s )} = m \times \frac{N}{{r}^{2}} + {〚 ⌊ \frac{v}{{r}^{( s - 1 )}} ⌋ \times \frac{N}{r} 〛}_{N} + {〚 k 〛}_{{r}^{( s - 1 )}} + ⌊ \frac{v}{{r}^{s}} ⌋ \times {r}^{( s - 1 )} \qquad ( Equation 14 )$$

for the DIF process, and for the DIT process, the read address generator can be determined as follows:

$${RAG}_{( m , v , s )} = m \times ( \frac{N}{{r}^{( s + 1 )}} ) + {〚 v 〛}_{{r}^{( S - s )}} + ⌊ \frac{v}{{r}^{( S - s )}} ⌋ \times {r}^{( S + 1 - s )} , \qquad ( Equation 15 )$$

for the DIT process where m=0, 1, . . . , r−1, v=0, 1, . . . , V−1 and s=0, 1, . . . , S, S=logᵣ N−1 in which [symbol] x [symbol] _{N} represents the operation x modulo N and └x┘ represents the integer part operator of x.

For both cases, the l^{th} processed butterfly's output X_{(l,v,s)} for the v^{th} word at the s^{th} stage can be stored into the memory address location can be determined according to the following equation:

WAG_{(l,v,s)}=l(N/r)+v. (Equation 16)

In this example, the input data and the output data are in natural order during each stage of the FFT process according to an Ordered Input Ordered Output (OIOO) algorithm.

The coefficients multipliers (Twiddle Factors) can be determined during each stage. The coefficient address generator values can be fed to the m^{th} butterfly's input of v^{th} word x₍ₘ₎ at the s^{th} stage (s^{th} iteration), and can be determined according to the following equation:

$${CAG}_{( m , v , s )} = {〚 l \times ( m V + ⌊ \frac{v}{{r}^{s}} ⌋ {r}^{s} ) 〛}_{N} , \qquad ( Equation 17 )$$

for the DIF process, and according to the following equation for the DIT process:

$${CAG}_{( m , v , s )} = {〚 m \times ( lV + ⌊ \frac{v}{{r}^{( S - s )}} ⌋ \times {r}^{( S - s )} ) 〛}_{N} . \qquad ( Equation 18 )$$

By examining Equations 16 and 17, it can be observed that the data are grouped with their corresponding coefficients multipliers during each stage due to the fact that the mth coefficient multiplier of the lth butterfly's output shift, if and only if, v(v=0, 1, . . . , V−1) will be equal to r(S−s) in the DIF process or v=rs in the DIT process. As a result and since V=N/r=rS; the total number of shifts during each stage in the DIT process would be rs, and the total number of shifts during each stage in the DIF process is r(S−s). Therefore, by implementing a word counter r(S−s) (wordcounter=0, 1, . . . , r(S−s)−1) and a shifting counter rs (shiftcounter=0, 1, . . ., rs−1) in the DIT process (or a word counter rs and a shifting counter r(S−s) in the DIF process), it is possible to obtain high efficiency DIT/DIF radix-r algorithms in which the access to the coefficient multiplier's memory is reduced compared to conventional radix-r DIT/DIF algorithms.

In addition, the occurrence of the multiplication by one (i.e. the elements of the twiddle factor matrix illustrated in Equation 8 are all equal to one) can be easily predicted when the shifting counter in both cases is equal to zero (i.e. v<rs or v<r(S−s)). By predicting when the shifting counter is equal to zero, the trivial multiplication by one (w0) during the entire FFT process can be avoided.

With the same reasoning as above, the complexity of the DIT/DIF reading generators can be obtained and replaced with simple counters. Further reductions in computation and further reductions in the coefficient multiplier's memory access can also be realized. For simplicity and in order to reduce the complexity of the equations that will follow, the terms can be defined as follows:

$$α = {r}^{( S - s )} = {2}^{( S - s )} {α}_{λ} = \{ \begin{matrix}α & for λ = 0 \\ λα & for λ \geq 1\end{matrix} \\ χ = α {χ}_{λ} = \{ \begin{matrix}0 & for λ = 0 \\ λα & for λ \geq 1\end{matrix} \\ β = r \times {r}^{( S - s )} = 2 \times {2}^{( S - s )} {β}_{λ} = λβ . \qquad ( Equation 19 )$$

For the radix 2 case, Equation 12 at the s^{th} stage can be rewritten as follows:

$$[ \begin{matrix}{X}_{( k + {χ}_{λ} )} \\ {X}_{( k + {χ}_{λ} + V )}\end{matrix} ] = [ \begin{matrix}{x}_{( n + {β}_{λ} )} + {x}_{( n + {β}_{λ} + {α}_{λ} )} {w}_{N}^{{〚 ⌊ v / {2}^{( S - s )} ⌋ {2}^{( S - s )} 〛}_{N}} \\ {x}_{( n + {β}_{λ} )} + {x}^{( n + {β}_{λ} + {α}_{λ} )} {w}_{N}^{{〚 \frac{N}{2} + ⌊ v / {2}^{( S - s )} ⌋ {2}^{( S - s )} 〛}_{N}}\end{matrix} ] , \qquad ( Equation 20 )$$

that could be simplified as follows:

$$[ \begin{matrix}{X}_{( k + {χ}_{λ} )} \\ {X}_{( k + {χ}_{λ} + V )}\end{matrix} ] = [ \begin{matrix}{x}_{( n + {β}_{λ} )} + {x}_{( n + {β}_{λ} + {α}_{λ} )} {w}_{N}^{{〚 ⌊ v / {2}^{( S - s )} ⌋ {2}^{( S - s )} 〛}_{N}} \\ {x}_{( n + {β}_{λ} )} - {x}_{( n + {β}_{λ} + {α}_{λ} )} {w}_{N}^{{〚 ⌊ v / {2}^{( S - s )} ⌋ {2}^{( S - s )} 〛}_{N}}\end{matrix} ] , \qquad ( Equation 21 )$$

where x denotes the input from the previous stage and X represents the transform output.

By replacing the term └v/2^{(S-s)}┘ with the term λ which is the value of the shifting counter that cannot exceed 2^{s}−1, Equation 21 may be written to have the final form as follows:

$$[ \begin{matrix}{X}_{( k + {χ}_{λ} )} \\ {X}_{( k + {χ}_{λ} + V )}\end{matrix} ] = [ \begin{matrix}{x}_{( n + {β}_{λ} )} + {x}_{( n + {β}_{λ} + {α}_{λ} )} {w}_{N}^{{α}_{λ}} \\ {x}_{( n + {β}_{λ} )} - {x}_{( n + {β}_{λ} + {α}_{λ} )} {w}_{N}^{{α}_{λ}}\end{matrix} ] . \qquad ( Equation 22 )$$

For the first iteration (s=0), the maximum value that v can attain is V−1. As a result, the term └v/V┘=λ is always zero; therefore, for the first iteration, Equation 22 can be written as follows:

$$[ \begin{matrix}{X}_{( k )} \\ {X}_{( k + V )}\end{matrix} ] = [ \begin{matrix}{x}_{( n )} + {x}_{( n + α )} \\ {x}_{( n )} - {x}_{( n + α )}\end{matrix} ] , \qquad ( Equation 23 )$$

During the second iteration (s=1), the term λ is either zero or one as a result Equation 22 and can be expressed as follows:

$$[ \begin{matrix}{X}_{( k )} \\ {X}_{( k + V )} \\ {X}_{( k + α )} \\ {X}_{( k + α + V )}\end{matrix} ] = [ \begin{matrix}{x}_{( n )} + {x}_{( n + α )} \\ {x}_{( n )} - {x}_{( n + α )} \\ {x}_{( n + β )} + {x}_{( n + β + α )} {w}_{N}^{α} \\ {x}_{( n + β )} - {x}_{( n + β + α )} {w}_{N}^{α}\end{matrix} ] , \qquad ( Equation 24 )$$

which could be simplified as follows:

$$[ \begin{matrix}{X}_{( k )} \\ {X}_{( k + V )} \\ {X}_{( k + α )} \\ {X}_{( k + α + V )}\end{matrix} ] = [ \begin{matrix}{x}_{( n )} + {x}_{( n + α )} \\ {x}_{( n )} - {x}_{( n + α )} \\ {x}_{( n + β )} + ( - j ) {x}_{( n + β + α )} \\ {x}_{( n + β )} - ( - j ) {x}_{( n + β + α )}\end{matrix} ] , \qquad ( Equation 25 )$$

Finally, for the third iteration (s=2), the term λ could have the following values 0, 1, 2 and 3, and, as a result, Equation 22 can be illustrated as follows:

$$[ \begin{matrix}{X}_{( k )} \\ {X}_{( k + V )} \\ {X}_{( k + α )} \\ {X}_{( k + α + V )} \\ {X}_{( k + 2 α )} \\ {X}_{( k + 2 α + V )} \\ {X}_{( k + 3 α )} \\ {X}_{( k + 3 α + V )}\end{matrix} ] = [ \begin{matrix}{x}_{( n )} + {x}_{( n + α )} \\ {x}_{( n )} - {x}_{( n + α )} \\ {x}_{( n + β )} + {x}_{( n + β + α )} {w}_{N}^{α} \\ {x}_{( n + β )} - {x}_{( n + β + α )} {w}_{N}^{α} \\ {x}_{( n + 2 β )} + {x}_{( n + 2 β + 2 α )} {w}_{N}^{2 α} \\ {x}_{( n + 2 β )} - {x}_{( n + 2 β + 2 α )} {w}_{N}^{2 α} \\ {x}_{( n + 3 β )} + {x}_{( n + 3 β + 3 α )} {w}_{N}^{3 α} \\ {x}_{( n + 3 β )} - {x}_{( n + 3 β + 3 α )} {w}_{N}^{3 α}\end{matrix} ] , \qquad ( Equation 26 )$$

The matrices of Equation 26 may be simplified as follows:

$$[ \begin{matrix}{X}_{( k )} \\ {X}_{( k + V )} \\ {X}_{( k + α )} \\ {X}_{( k + α + V )} \\ {X}_{( k + 2 α )} \\ {X}_{( k + 2 α + V )} \\ {X}_{( k + 3 α )} \\ {X}_{( k + 3 α + V )}\end{matrix} ] = [ \begin{matrix}{x}_{( n )} + {x}_{( n + α )} \\ {x}_{( n )} - {x}_{( n + α )} \\ {x}_{( n + β )} + ( \frac{\sqrt{2}}{2} ( 1 - j ) ) \times {x}_{( n + β + α )} \\ {x}_{( n + β )} - ( \frac{\sqrt{2}}{2} ( 1 - j ) ) \times {x}_{( n + β + α )} \\ {x}_{( n + 2 β )} + ( - j ) \times {x}_{( n + 2 β + 2 α )} \\ {x}_{( n + 2 β )} - ( - j ) \times {x}_{( n + 2 β + 2 α )} \\ {x}_{( n + 3 β )} + ( \frac{- \sqrt{2}}{2} ( 1 + j ) ) \times {x}_{( n + 3 β + 3 α )} \\ {x}_{( n + 3 β )} - ( \frac{- \sqrt{2}}{2} ( 1 + j ) ) \times {x}_{( n + 3 β + 3 α )}\end{matrix} ] , \qquad ( Equation 27 )$$

and the signal flow graph of an 8 point DIT FFT according to Equation 27 is illustrated in FIG. 9.

FIG. 9 depicts a signal flow graph 900 of an 8-point DIT FFT, in accordance with certain embodiments of the present disclosure. The graph 900 may include a plurality of summing nodes, generally indicated at 902. Further, the graph 900 can include reordering operations, generally indicated at 904. The graph 900 depicts a plurality of summing nodes, generally indicated at 906, and two multiplier nodes 907A and 907B. Further, the graph 900 may include a plurality of reordering operations, generally indicated at 908. Additionally, the graph 900 can include multipliers 909A, 909B, and 909C and a plurality of summing nodes, generally indicated at 910.

The multiplication by −j at 907A and 907B in FIG. 9 can be easily incorporated in the additions by switching the real and imaginary parts of the data, and the multiplication of the input data by

$$\pm \frac{\sqrt{2}}{2} \pm j \frac{\sqrt{2}}{2}$$

may cost 2 real multiplications. As a result, the total cost of real multiplication of the proposed structure can include 4 real multiplication operations, as compared to the structure of FIG. 4 that would cost 20 real multiplication operations (i.e., 5 complex multiplications).

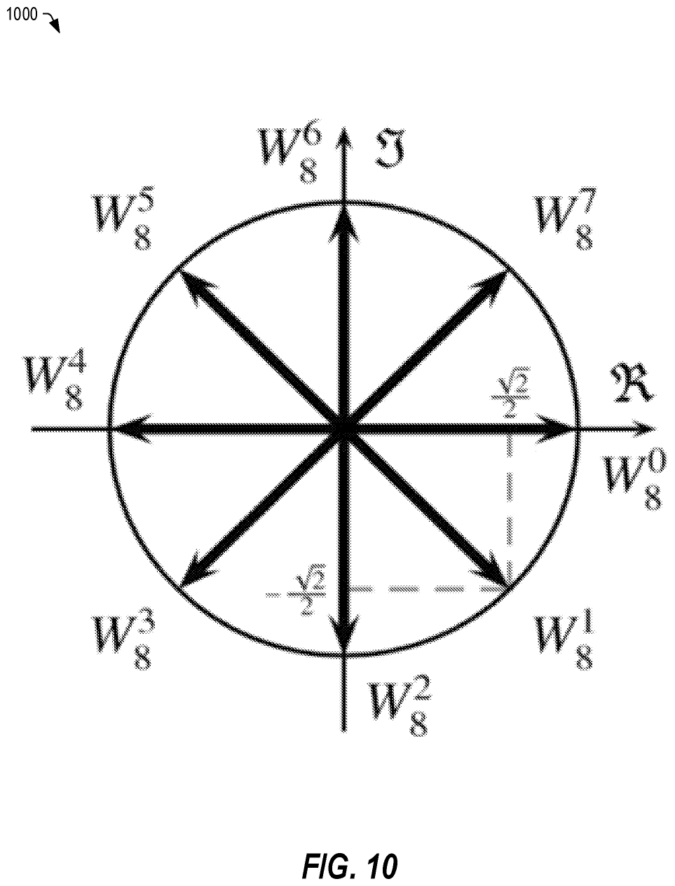

FIG. 10 depicts a graph 800 of the 8^{th} root of unity, in accordance with certain embodiments of the present disclosure. The graph 800 depicts complex numbers including imaginary (I) and real (R) components. In some embodiments, the complex numbers may result in a value of one when raised to some positive integer power n.

From Equations 23, 25, and 27, the first, second, and the third iterations of the DIT FFT process may include only trivial multiplication operations. In order to predict the occurrence of the trivial multiplication in the rest of the iterations (i.e. s≥3), which is a multiple of w8 as shown in FIG. 10, the following discussion introduces the term 2(s−2) (hereinafter referred to as a “separator”) that will subdivide 2 s into 4 sub regions. The choice of the separator's value will be based on the following equations. For Lemma 1, for all stages of the OIOOO FFT algorithm, the product of 2(s−2) and 2(S−s) is always =N/8∀s. This identity can be proven according to the following equations:

$${s}^{( S - s )} \times {2}^{( s - 2 )} = {2}^{( S - 2 )} = \frac{N}{{2}^{3}} = \frac{N}{8} . \qquad ( Equation 28 )$$

For different values of λ, Equation 22 provides the following values:

$$i . λ = 0$$

$$ii . {λ}_{0} ∈ 1 ⋯ {2}^{( s - 2 )} [ \text{?} \\ iii . λ = {2}^{( s - 2 )} \\ iv . {λ}_{1} ∈ {2}^{( s - 2 )} + 1 ⋯ 2 \times {2}^{( s - 2 )} [ \text{?} \\ \text{?} \text{indicates text missing or illegible when filed}$$

For the i^{th} case at the s^{th} iteration (stage), Equation 22 can be expressed as follows:

$$[ \begin{matrix}X ( k ) \\ X ( k + V )\end{matrix} ] = [ \begin{matrix}x ( n ) + x ( n + α ) \\ x ( n ) - x ( n + α )\end{matrix} ] , \qquad ( Equation 29 )$$

For the iii^{th} case, Equation 22 can be expressed as follows:

$$[ \begin{matrix}X ( k + {2}^{( S - 2 )} ) \\ X ( k + {2}^{( S - 2 )} + V )\end{matrix} ] = [ \begin{matrix}x ( n + {2}^{( S - 1 )} ) + x ( n + {2}^{( S - 1 )} + {2}^{( S - 2 )} ) τ \\ x ( n + {2}^{( S - 1 )} ) - x ( n + {2}^{( S - 1 )} + {2}^{( S - 2 )} ) τ\end{matrix} ] , \\ where τ = \frac{\sqrt{2}}{2} ( 1 - j ) . \qquad ( Equation 30 )$$

For v^{th} and vii^{th} cases, Equation 22 can be expressed, respectively, as follows:

$$\begin{matrix} [ \begin{matrix}{X}_{( k + {2}^{( S - 1 )} )} \\ {X}_{( k + {2}^{( S - 1 )} + V )}\end{matrix} ] = [ \begin{matrix}{x}_{( n + {2}^{S} )} + {x}_{( n + {2}^{S} + {2}^{( S - 1 )} )} ( - j ) \\ {x}_{( n + {2}^{S} )} - {x}_{( n + {2}^{S} + {2}^{( S - 1 )} )} ( - j )\end{matrix} ] . & ( Equation 31 ) \\ [ \begin{matrix}{X}_{( k + 3 \times {2}^{( S - 2 )} )} \\ {X}_{( k + 3 \times {2}^{( S - 2 )} + V )}\end{matrix} ] = [ \begin{matrix}{x}_{( n + 3 \times {2}^{( S - 1 )} )} + {x}_{( n + 3 \times {2}^{( S - 1 )} + 3 \times {2}^{( S - 2 )} )} σ \\ {x}_{( n + 3 \times {2}^{( S - 1 )} )} - {x}_{( n + 3 \times {2}^{( S - 1 )} + 3 \times {2}^{( S - 2 )} )} σ\end{matrix} ] , \\ where σ = \frac{- \sqrt{2}}{2} ( 1 + j ) . & ( Equation 32 )\end{matrix}$$

Therefore, for s≥3, there are four sets of size r^{(S-s)} words that have

$$\frac{\pm \sqrt{2}}{2} ( 1 \pm j ) ,$$

1, and −j as trivial multiplications that can be grouped. Grouping the “trivial” multiplications can yield the following expression:

$$[ \begin{matrix}{X}_{( k )} \\ {X}_{( k + V )} \\ {X}_{( k + {2}^{( S - 2 )} )} \\ {X}_{( k + {2}^{( S - 2 ) + V} )} \\ {X}_{( k + 2 \times {2}^{( S - 2 )} )} \\ {X}_{( k + 2 \times {2}^{( S - 2 )} + V )} \\ {X}_{( k + 3 \times {2}^{( S - 2 )} )} \\ {X}_{( k + 3 \times {2}^{( S - 2 )} + V )}\end{matrix} ] = [ \begin{matrix}{x}_{( n )} + {x}_{( n + α )} \\ {x}_{( n )} - {x}_{( n + α )} \\ {x}_{( n + {2}^{( S - 1 )} )} + {x}_{( n + {2}^{( S - 1 )} + {2}^{( S - 2 )} )} τ \\ {x}_{( n + {2}^{( S - 1 )} )} - {x}_{( n + {2}^{( S - 1 )} + {2}^{( S - 2 )} )} τ \\ {x}_{( n + {2}^{S} )} + {x}_{( n + {2}^{S} + 2 \times {2}^{( S - 2 )} )} ( - j ) \\ {x}_{( n + {2}^{S} )} - {x}_{( n + {2}^{S} + 2 \times {2}^{( S - 2 )} )} ( - j ) \\ {x}_{( n + 3 \times {2}^{( S - 1 )} )} + {x}_{( n + 3 \times {2}^{( S - 1 )} + 3 \times {2}^{( S - 2 )} )} σ \\ {x}_{( n + 3 \times {2}^{( S - 1 )} )} + {x}_{( n + 3 \times {2}^{( S - 1 )} - 3 \times {2}^{( S - 2 )} )} σ\end{matrix} ] , \qquad ( Equation 33 )$$

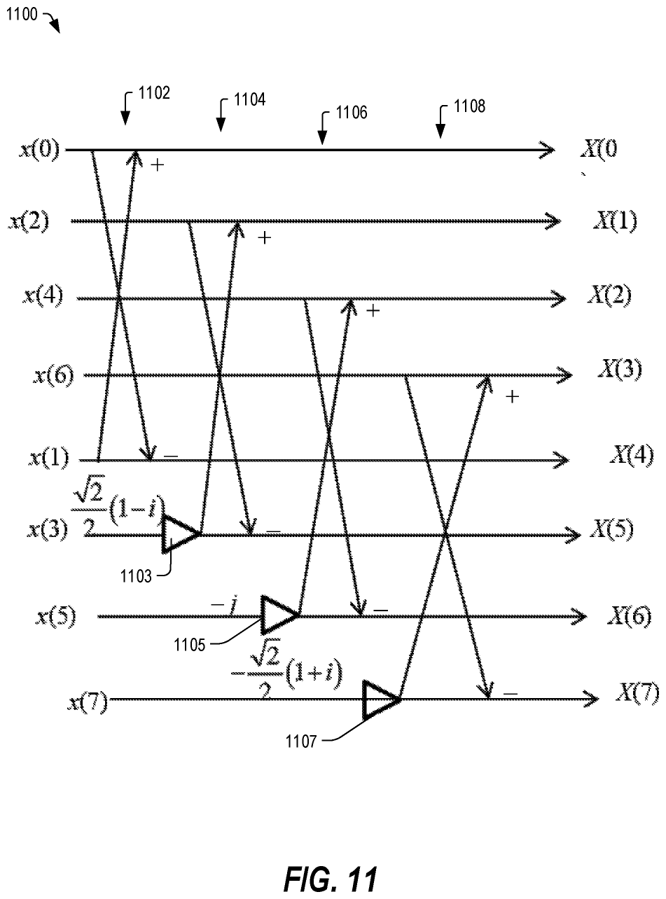

and the resulting structure for this particular case is depicted in FIG. 11.

FIG. 11 depicts a graph 1100 of a Radix-2³ FFT butterfly structure for a trivial computation, in accordance with certain embodiments of the present disclosure. The graph 1100 may include summing nodes, generally indicated at 1103. The graph 1100 may include a complex multiplier node 1103 and can include summing nodes, generally indicated at 1104. The graph 1100 may further include a trivial multiplier 1105 and can include summing nodes, generally indicated at 1106. The graph 1100 can further include a complex multiplier 1107 and can include summing nodes 1108, generally indicated at 1108.

For the other cases and by comparing the domains of λ, each domain of λ can be represented as follows:

$$\begin{matrix}λ ∈ ξ {r}^{( s - 2 )} + 1 & ξ {r}^{( s - 2 )} + 2 & ⋯ & ξ {r}^{( s - 2 )} + {r}^{( s - 2 )}\end{matrix} [ \text{?} , \\ \text{?} \text{indicates text missing or illegible when filed} \qquad ( Equation 34 )$$

where ξ=0, 1, 2 and 3. Other cases can be expressed as follows:

$$[ \begin{matrix}{X}_{( k + {α}_{{λ}_{ξ}} )} \\ {X}_{( k + {α}_{{λ}_{ξ}} + V )}\end{matrix} ] = [ \begin{matrix}{X}_{( n + {β}_{{λ}_{ξ}} )} + {X}_{( n + {β}_{{λ}_{ξ}} + {α}_{{λ}_{ξ}} )} {w}_{N}^{{α}_{{λ}_{ξ}}} \\ {X}_{( n + {β}_{{λ}_{ξ}} )} - {X}_{( n + {β}_{{λ}_{ξ}} + {α}_{λ} )} {w}_{N}^{{α}_{{λ}_{ξ}}}\end{matrix} ] . \qquad ( Equation 35 )$$

By regrouping these four cases where each of which will share the same coefficient multiplier, the following expression may be realized:

$$[ \begin{matrix}{X}_{( k + {α}_{λ} )} \\ {X}_{( k + {α}_{λ} + V )} \\ {X}_{( k + {r}^{( s - 2 )} {α}_{λ} )} \\ {X}_{( k + {r}^{( s - 2 )} {α}_{λ} + V )} \\ {X}_{( k + 2 {r}^{( s - 2 )} {α}_{λ} )} \\ {X}_{( k + 2 {r}^{( s - 2 )} {α}_{λ} + V )} \\ {X}_{( k + 3 {r}^{( s - 2 )} {α}_{λ} )} \\ {X}_{( k + 3 {r}^{( s - 2 )} {α}_{λ} + V )}\end{matrix} ] = [ \begin{matrix}{x}_{( n + {β}_{λ} )} + {x}_{( n + {β}_{λ} + {α}_{λ} )} {w}_{N}^{{α}_{λ}} \\ {x}_{( n + {β}_{λ} )} - {x}_{( n + {β}_{λ} + {α}_{λ} )} {w}_{N}^{{α}_{λ}} \\ {x}_{( n + {r}^{( s - 2 )} {β}_{λ} )} + {x}_{( n + {r}^{( s - 2 )} {β}_{λ} + {r}^{( s - 2 )} {α}_{λ} )} {w}_{N}^{( {r}^{( s - 2 )} + λ ) α} \\ {x}_{( n + {r}^{( s - 2 )} {β}_{λ} )} - {x}_{( n + {r}^{( s - 2 )} {β}_{λ} + {r}^{( s - 2 )} {α}_{λ} )} {w}_{N}^{( {r}^{( s - 2 )} + λ ) α} \\ {x}_{( n + 2 {r}^{( s - 2 )} {β}_{λ} )} + {x}_{( n + 2 {r}^{( s - 2 )} {β}_{λ} + 2 {r}^{( s - 2 )} {α}_{λ} )} {w}_{N}^{( 2 {r}^{( s - 2 )} + λ ) α} \\ {x}_{( n + 2 {r}^{( s - 2 )} {β}_{λ} )} - {x}_{( n + 2 {r}^{( s - 2 )} {β}_{λ} + 2 {r}^{( s - 2 )} {α}_{λ} )} {w}_{N}^{( 2 {r}^{( s - 2 )} + λ ) α} \\ {x}_{( n + 3 {r}^{( s - 2 )} {β}_{λ} )} + {x}_{( n + 3 {r}^{( s - 2 )} {β}_{λ} + 3 {r}^{( s - 2 )} {α}_{λ} )} {w}_{N}^{( 3 {r}^{( s - 2 )} + λ ) α} \\ {x}_{( n + 3 {r}^{( s - 2 )} {β}_{λ} )} - {x}_{( n + 3 {r}^{( s - 2 )} {β}_{λ} + 3 {r}^{( s - 2 )} {α}_{λ} )} {w}_{N}^{( 3 {r}^{( s - 2 )} + λ ) α}\end{matrix} ] , \qquad ( Equation 36 )$$

where λ∈1 . . . 2^{(s-2)}[ [symbol] . The entity w_{N}^{(2r}^{^{(s−2)}}^{+λ)α} in the fifth and the sixth terms of Equation 36 can be simplified as follows:

$${w}_{N}^{( 2 {r}^{( s - 2 )} + λ ) α} = {w}_{N}^{λα} {w}_{N}^{2 {r}^{( s - 2 )} α} = {w}_{N}^{{α}_{λ}} {w}_{N}^{\frac{N}{4}} = - {jw}_{N}^{{α}_{λ}} \qquad ( Equation 37 )$$

In this example, the domain for λ for the entities w_{N}^{(r}^{^{(s−2)}}^{+λ)α} and w_{N}^{(3r}^{^{(s−2)}}^{+λ)α} can be defined as follows:

$$λ ∈ {2}^{( s - 2 )} ⋯ 1 [ \text{?} . \\ \text{?} \text{indicates text missing or illegible when filed} \qquad ( Equation 38 )$$

These entities could be expressed, respectively, as follows:

$$\begin{matrix}{w}_{N}^{( {r}^{( s - 2 )} + ( {r}^{( s - 2 )} - λ ) ) α} = {w}_{N}^{2 {r}^{( s - 2 )} α - λα} = {w}_{N}^{- ( {α}_{λ} - \frac{N}{4} )} = conj ( {jw}_{N}^{{α}_{λ}} ) , & ( Equation 39 ) \\ {w}_{N}^{( 3 {r}^{( s - 2 )} + ( {r}^{( s - 2 )} - λ ) ) α} = {w}_{N}^{4 {r}^{( s - 2 )} α - λα} = {w}_{N}^{- {α}_{λ}} {w}_{N}^{\frac{N}{2}} = - conj ( {jw}_{N}^{{α}_{λ}} ) , & ( Equation 40 )\end{matrix}$$

where the variable conj in Equations 39 and 40 refers to the complex conjugate process. As a result, Equation 36 can be rewritten as follows:

$$[ \begin{matrix}{X}_{( k + {α}_{λ} )} \\ {X}_{( k + {α}_{λ} + V )} \\ {X}_{( k + {r}^{( s - 2 )} {α}_{λ} )} \\ {X}_{( k + {r}^{( s - 2 )} {α}_{λ} + V )} \\ {X}_{( k + 2 {r}^{( s - 2 )} {α}_{λ} )} \\ {X}_{( k + 2 {r}^{( s - 2 )} {α}_{λ} + V )} \\ {X}_{( k + 3 {r}^{( s - 2 )} {α}_{λ} )} \\ {X}_{( k + 3 {r}^{( s - 2 )} {α}_{λ} + V )}\end{matrix} ] = [ \begin{matrix}{x}_{( n + {β}_{λ} )} + {x}_{( n + {β}_{λ} + {α}_{λ} )} {w}_{N}^{{α}_{λ}} \\ {x}_{( n + {β}_{λ} )} - {x}_{( n + {β}_{λ} + {α}_{λ} )} {w}_{N}^{{α}_{λ}} \\ {x}_{( n + {r}^{( s - 2 )} {β}_{λ} )} + {x}_{( n + 2 {r}^{( s - 2 )} {β}_{λ} - ( 2 {r}^{( s - 2 )} - 1 ) {α}_{λ} )} \times conj ( {jw}_{N}^{{α}_{λ}} ) \\ {x}_{( n + {r}^{( s - 2 )} {β}_{λ} )} - {x}_{( n + 2 {r}^{( s - 2 )} {β}_{λ} - ( 2 {r}^{( s - 2 )} - 1 ) {α}_{λ} )} \times conj ( {jw}_{N}^{{α}_{λ}} ) \\ {x}_{( n + 2 {r}^{( s - 2 )} {β}_{λ} )} + {x}_{( n + 2 {r}^{( s - 2 )} {β}_{λ} + 2 {r}^{( s - 2 )} {α}_{λ} )} ( - j ) {w}_{N}^{{α}_{λ}} \\ {x}_{( n + 2 {r}^{( s - 2 )} {β}_{λ} )} - {x}_{( n + 2 {r}^{( s - 2 )} {β}_{λ} + 2 {r}^{( s - 2 )} {α}_{λ} )} ( - j ) {w}_{N}^{{α}_{λ}} \\ {x}_{( n + 3 {r}^{( s - 2 )} {β}_{λ} )} + {x}_{( n + 3 {r}^{( s - 2 )} {β}_{λ} - ( 3 {r}^{( s - 2 )} - 1 ) {α}_{λ} )} \times conj ( {w}_{N}^{{α}_{λ}} ) \\ {x}_{( n + 3 {r}^{( s - 2 )} {β}_{λ} )} - {x}_{( n + 3 {r}^{( s - 2 )} {β}_{λ} - ( 3 {r}^{( s - 2 )} - 1 ) {α}_{λ} )} \times conj ( {w}_{N}^{{α}_{λ}} )\end{matrix} ] \qquad ( Equation 41 )$$

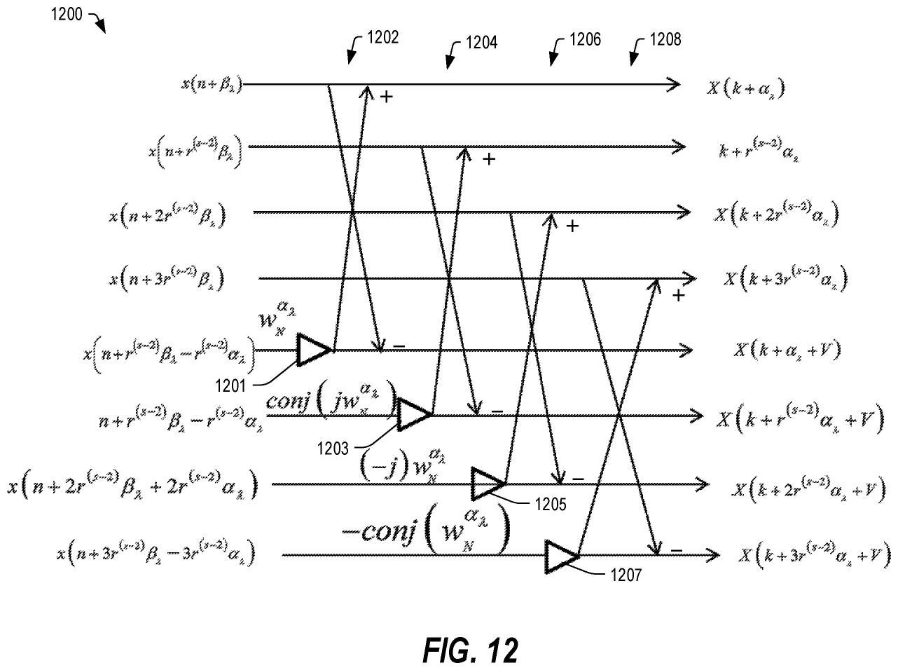

From Equation 41, the FFT radix 2³ butterfly can be derived as depicted and described below with respect to FIG. 12.

FIG. 12 depicts a graph of a Radix-2³ FFT butterfly structure 1200 for a non-trivial computation, in accordance with certain embodiments of the present disclosure. In this example, one complex coefficient multiplier (or twiddle factor) can be used for each of the eight complex inputs. In addition, the coefficient multiplier memory can be accessed once for each 4×2^{s} word (a set of two inputs) for the DIT process. For the DIF process, where s is the actual stage (iteration) of the FFT process and where S represents a total number of stages of the FFT process, the coefficient multiplier memory can be accessed once for every 2^{S-s)} word where (S=log₂ (N)−1).

In FIG. 12, the structure 1200 may include a complex multiplier node 1201 and can include summing nodes, generally indicated at 1202. The structure 1200 may also include a complex multiplier node 1203 and summing nodes, generally indicated at 1204. Further, the structure 1200 can include a complex multiplier node 1205 and summing nodes, generally indicated at 1206. The structure 1200 can also include a complex multiplier node 1207 and summing nodes 1208, generally indicated at 1208.

Compared to conventional methods that require two memory accesses per four inputs and one memory access per two inputs, the FFT radix-2³ butterfly structure 1200 may use one memory access per eight inputs. Further, the multiplication by

$$\pm \frac{\sqrt{2}}{2} \pm j \frac{\sqrt{2}}{2} can$$

be predicted, where the number of arithmetical operations to complete the complex multiplication can be reduced from six to two as shown in Tables 1 and 2 below. Further, the reduction in memory accesses to the coefficient multiplier's memory is illustrated in Table 3 for different FFT sizes.

In Tables 1-3, a conventional method #1 (“DIT”) refers to a method described in Y. Wang and al, “Novel Memory Reference Reduction Methods for FFT Implementations on DSP Processors”, IEEE Transactions on signal processing, Vol. 55, No. 5, May 2007. Further, a conventional method #2 (“TMS”) refers to DIF radix-2 FFT code taken from “TMS320C64x DSP Library Programmer's Reference”, Literature Number: SPRU565B, October 2003, (code DSP-radix-2, p. 4-9, 4-10).

TABLE 1
Comparison in terms of real multiplication between
conventional methods versus the Radix-2³ FFT method

| | | | | Multiplication reduction | |
|---|---|---|---|---|---|
| | | | Radix-2³ | (%) | |
| N | TMS | DIT | FFT | TMS | DIT |
| 8 | 48 | 8 | 4 | 91.7 | 50 |
| 16 | 128 | 40 | 24 | 81.25 | 40 |
| 32 | 320 | 136 | 88 | 72.5 | 35.29 |
| 64 | 768 | 392 | 264 | 65.62 | 32.65 |
| 128 | 1792 | 1032 | 712 | 60.26 | 31.1 |
| 256 | 4096 | 2568 | 1800 | 56.05 | 29.90 |
| 512 | 9216 | 6152 | 4360 | 52.69 | 29.12 |
| 1024 | 20480 | 14344 | 10248 | 49.96 | 28.55 |
| 2048 | 45056 | 32776 | 23560 | 47.70 | 28.11 |

TABLE 2
Comparison in terms of real addition between the conventional
methods versus the Radix-2³ FFT method

| | | | | Addition reduction | |
|---|---|---|---|---|---|
| | | | Radix-2³ | (%) | |
| N | TMS | DIT | FFT | TMS | DIT |
| 8 | 72 | 52 | 48 | 33.34 | 7.6 |
| 16 | 192 | 148 | 140 | 27.08 | 5.40 |
| 32 | 480 | 392 | 380 | 20.83 | 3.06 |
| 64 | 1152 | 988 | 972 | 15.62 | 1.6 |
| 128 | 2688 | 2400 | 2380 | 11.45 | 0.83 |
| 256 | 6144 | 5668 | 5644 | 8.13 | 0.77 |
| 512 | 13824 | 13096 | 13068 | 5.46 | 0.21 |
| 1024 | 30720 | 28740 | 28708 | 6.54 | 0.11 |
| 2048 | 67584 | 66612 | 66572 | 1.49 | 0.06 |

TABLE 3
Comparison in terms of memory accesses to the coefficient
multiplier in the conventional methods versus the Radix-2³
FFT method where each complex access is counted as 1:

| | |
|---|---|
| | Memory accesses |
| Radix-2³ | reduction (%) |

| N | TMS | DIT | FFT | TMS | DIT |
|---|---|---|---|---|---|
| 8 | 7 | 1 | 0 | 100 | 100 |
| 16 | 15 | 5 | 2 | 86.7 | 60 |
| 32 | 31 | 15 | 8 | 74.2 | 46.7 |
| 64 | 63 | 37 | 22 | 65.1 | 40.5 |
| 128 | 127 | 83 | 52 | 59.1 | 37.35 |
| 256 | 255 | 177 | 114 | 55.3 | 35.6 |
| 512 | 511 | 367 | 240 | 53.1 | 34.7 |
| 1024 | 1023 | 749 | 494 | 51.7 | 34.1 |
| 2048 | 2047 | 1515 | 1004 | 49.1 | 33.7 |

Table 4 reveals simulation results of the conventional methods versus the Radix-2³ FFT method where the term “Loss” is defined as the ratio of the conventional method over the Radix-2³ FFT method.

TABLE 4
Comparative results in term of clock cycle of the conventional
methods versus the Radix-2³ FFT method for different FFT sizes

| | | | | Cycle Reductions (%) | |
|---|---|---|---|---|---|
| Length | TMS | DIT | Proposed | TMS | DIT |
| 64 | 5252 | 4210 | 3648 | 43.97 | 15.41 |
| 128 | 11363 | 9048 | 7612 | 49.28 | 18.86 |
| 256 | 24578 | 19246 | 15832 | 55.24 | 21.56 |
| 512 | 53025 | 40676 | 32852 | 61.41 | 23.82 |
| 1024 | 113984 | 85594 | 68048 | 67.51 | 25.78 |
| 2048 | 244063 | 179536 | 140748 | 73.40 | 27.56 |
| 4096 | 520574 | 375622 | 290760 | 79.04 | 29.19 |

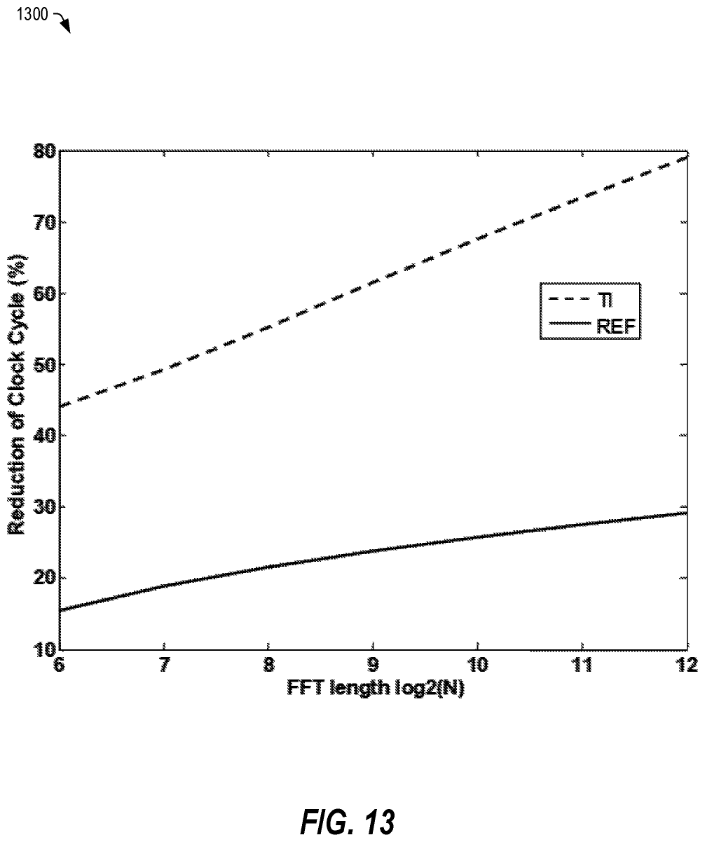

The ratio of the conventional method over the Radix-23 FFT method is described below with respect to FIG. 13.

FIG. 13 depicts a graph 1300 of a percentage reduction of clock cycles as a function of the FFT length for a TMS clock and a DIT clock, in accordance with certain embodiments of the present disclosure. The percentage reduction in clock cycles appears to increase substantially linearly as the FFT length (N) increases for the implementation of the Radix-2³ FFT method as compared to the reference. At a FFT length of log2(12), the Radix-2³ FFT method provides a 60% rejection in clock cycles as compared to the reference algorithm.

TABLE 5
Comparison of the coefficients multiplier's memory requirement of the
conventional methods versus the Radix-2³ FFT method where the size is
computed in term of bytes

| FFT Length | TMS | DIT | Proposed |
|---|---|---|---|
| N | 2N | N/2 − 2 | N/8 − 1 |

As can be seen from Table 5, the method described herein achieves a significant reduction in the coefficient multiplier's memory requirements in terms of bytes. In particular, the method described herein achieves a memory size reduction of one less than the number of bytes divided by 8, as compared to the DIT reduction of two less than half of the number of bytes.

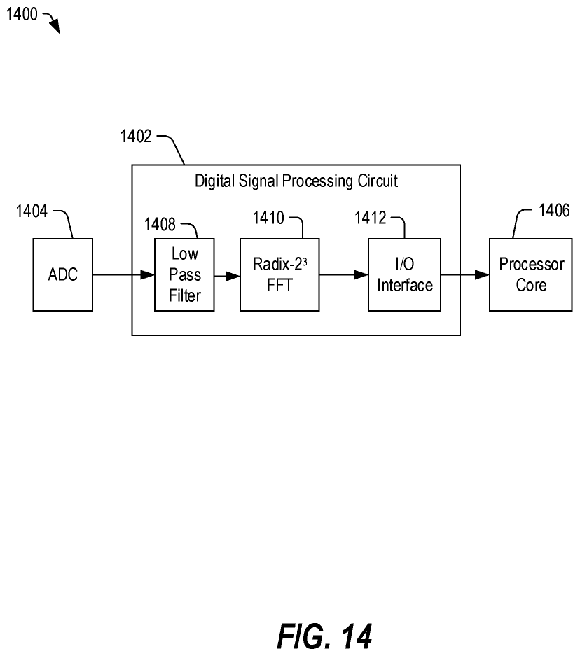

FIG. 14 depicts a block diagram of a signal processing system 1400 including a Radix-2³ FFT butterfly structure, in accordance with certain embodiments of the present disclosure. The system 1400 may include a digital signal processing (DSP) circuit 1402 having an input coupled to an analog-to-digital converter 1404, which may be configured to provide digital input stream to the DSP circuit 1402. The DSP circuit 1402 may further include an output coupled to a processor core 1406 or to another circuit or device. Other embodiments are also possible.

In some embodiments, the DSP circuit 1402 may include a low-pass filter 1408 including an input coupled to the output of the ADC 1404 and including an output. The DSP circuit 1402 may further include a radix-2³ FFT module 1410 including an input coupled to the low pass filter 1408 and including an output coupled to the processor cor 1406 through an input/output (I/O) interface 1412.

In conjunction with the systems, methods, and devices described above with respect to FIGS. 1-14 provides an efficient ordered input, ordered output radix 2³ algorithm that reduces the complexity and the computational effort in comparison to conventional methods. Furthermore, the systems, methods, and devices demonstrate a significant improvement in execution time in term of clock cycles compared to the conventional methods. In certain embodiments, the systems, methods, and devices may be configured to predict the 8th root of unity and to reduce the memory size needed to stock the coefficient multiplier to N/8. Accordingly, each of these improvements may contribute, individually and collectively, to an efficiency gain with respect to the processor, which may be realized in terms of faster processing, reduced memory consumption, reduced power consumption, and other improvements.

Although the present invention has been described with reference to preferred embodiments, workers skilled in the art will recognize that changes may be made in form and detail without departing from the scope of the invention.

What is claimed is:

1. A circuit comprising:
an input configured to receive a signal; and
a radix-2³ fast Fourier transform (FFT) processing element coupled to the input and configured to control variation of twiddle factors during calculation of a complete FFT through a plurality of processing stages of an FFT process, the radix-2³ FFT processing element configured to incorporate the twiddle factors and adder tree matrices of the calculation into a single stage.

2. The circuit of claim 1, wherein data input to the radix-2³ FFT processing element and data output by the radix-2³FFT processing element are in natural order during each stage of the plurality of processing stages of the FFT process.

3. The circuit of claim 1, wherein data within the radix-2³ FFT processing element are grouped with their corresponding coefficients multipliers during each stage of the plurality of processing stages of the FFT process.

4. The circuit of claim 1, wherein a total number of shifts during each stage in the plurality of processing stages of an FFT process configured to perform a decimation in time (DIT) process is represented as r^{s}.

5. The circuit of claim 1, wherein a total number of shifts during each stage in the plurality of processing stages of an FFT process configured to perform a decimation in frequency (DIF) process is represented as r^{(S-s)}.

6. The circuit of claim 1, wherein trivial multiplication by one operations are avoided during the plurality of processing stages of the FFT process.

7. A circuit comprising:
an input configured to receive a signal; and
a radix-2³ fast Fourier transform (FFT) processing element coupled to the input and configured to control variation of twiddle factors during calculation of a complete FFT through one or more stages.

8. The circuit of claim 7, wherein the radix-2^{3 FT} processing element is configured to incorporate the twiddle factors and adder tree matrices of the calculation into a single stage.

9. The circuit of claim 7, wherein data input to the radix-2³ FFT processing element and data output by the radix-2³ FFT processing element are in natural order during each stage of the one or more stages.

10. The circuit of claim 7, wherein the radix-2³ FFT processing element is configured to:
determine data from the signal at the input;
group each data element from the determined data with its corresponding coefficient multiplier to form grouped data; and
process the grouped data to produce an output signal.

11. The circuit of claim 7, wherein the radix-2³ FFT processing element is configured to perform a decimation in time (DIT) process having a number of shifts corresponding to a size N of the input data divided by the radix.

12. The circuit of claim 7, wherein the radix-2³ FFT processing element is configured to perform a decimation in frequency (DIF) process having a number of shifts corresponding to a number of words minus a number of stages.

13. The circuit of claim 7, wherein the radix-2³ FFT processing element avoids multiplication-by-one operations during the one or more stages of the FFT.

14. A circuit comprising:
an input configured to receive a signal; and
a radix-r fast Fourier transform (FFT) processing element coupled to the input, the radix-r FFT processing element configured to:
receive an input signal having a number of bits N;
reverse a bit order of the bits N;
decompose the bit order into groups of bits based on a base of a radix of the radix-r FFT processing element; and
process the groups of bits together with their coefficients to produce an output signal.

15. The circuit of claim 14, wherein the radix-r FFT processing element is configured to control variation of twiddle factors during calculation of an FFT through one or more stages of an FFT process.

16. The circuit of claim 14, wherein the radix-r FFT processing element is configured to incorporate the twiddle factors and adder tree matrices of the calculation into a single stage.

17. The circuit of claim 14, wherein data input to the radix-r FFT processing element and data output by the radix-r FFT processing element are in natural order during each stage of the one or more stages.

18. The circuit of claim 14, wherein the radix-r FFT processing element is configured to:
determine data from the signal at the input;
group each data element from the determined data with its corresponding coefficient multiplier to form grouped data; and
process the grouped data to produce an output signal.

19. The circuit of claim 14, wherein the radix-r FFT processing element is configured to:
perform a decimation in time (DIT) process having a number of shifts corresponding to a size N of the input data divided by the radix; and
perform a decimation in frequency (DIF) process having a number of shifts corresponding to a number of words minus a number of stages.

20. The circuit of claim 14, wherein the radix-r FFT processing element includes a radix-2³ FFT processing element to avoid multiplication-by-one operations during processing within the one or more stages.
